(19) United States
(12) Patent Application Publication
(10) Pub. No.: US 2016/0092622 A1
(43) Pub. Date: Mar. 31, 2016

(54) METHOD FOR MODELING MEDIUM AND LONG TERM WIND POWER OUTPUT MODEL OF MEDIUM AND LONG TERM OPTIMAL OPERATIONOF POWER SYSTEM

(71) Applicants: STATE GRID CORPORATION OF CHINA, Beijing (CN); STATE GRID GANSU ELECTRIC POWER CORPORATION, Lanzhou, Gansu Province (CN); GANSU ELECTRIC POWER CORPORATION WIND POWER TECHNOLOGY CENTER, Lanzhou, Gansu Province (CN)

(72) Inventors: NINGBO WANG, LANZHOU, GANSU PROVINCE (CN); MING MA, LANZHOU, GANSU PROVINCE (CN); YANHONG MA, LANZHOU, GANSU PROVINCE (CN); GUANGTU LIU, LANZHOU, GANSU PROVINCE (CN); LONG ZHAO, LANZHOU, GANSU PROVINCE (CN); QIANG ZHOU, LANZHOU, GANSU PROVINCE (CN); DINGMEI WANG, LANZHOU, GANSU PROVINCE (CN); LIANG LU, LANZHOU, GANSU PROVINCE (CN); JIANMEI ZHANG, LANZHOU, GANSU PROVINCE (CN); QINGQUAN LV, LANZHOU, GANSU PROVINCE (CN)

(21) Appl. No.: 14/893,012

(22) PCT Filed: Apr. 2, 2014
(86) PCT No.: PCT/CN2014/000362

§ 371 Date: Nov. 20, 2015

(30) Foreign Application Priority Data
May 20, 2013 (CN) 201310186332.9

(51) Int. Cl. G06F 17/50

(52) U.S. Cl. CPC G06F 17/5009

(57) ABSTRACT

Disclosed is a method for modeling a medium and long term wind power output model optimally operating in a medium and long term in a power system. By calculating the wind power output of the power system during daily peak time period, daily valley time period, and daily shoulder load time period, and optimizing wind power output data during the daily shoulder load time period, the capacity substitute benefit of wind power generation is rationally taken into account, the operation reliability level of the power system is guaranteed, the bidirectional peak regulation characteristic of wind power output is considered, the peak regulation balance of the power system is guaranteed, the benefits of energy conservation and emission reduction of wind power resources are fully exerted, the highest utilization rate of the wind power generation capacity is guaranteed, the feature of low wind power schedulability is fully taken into account, the randomness and volatility of wind power output are correctly simulated, the practical situation of a simulation project optimally operating in a medium and long term in the power system is met, and the purpose of better calculating the randomness, the volatility, the regionalism and bidirectional peak regulation performance of wind power generation and a correlation between same and loads is achieved.

### TECHNICAL FIELD

The present invention specifically involves a method for modeling a medium and long term wind power output model of a medium and long term optimal operation of a power system.

### BACKGROUND TECHNOLOGY

At present, a medium and long term optimal operation of a power system starts from the overall and practical condition of the power system. The optimal operation fully considers generating characteristics of various supplies in the power system, fully utilizes renewable energy resources in the power system such as hydropower and wind power, imitates the power generation dispatching of the typical day (or week) every month within the power system planning level year, and determines the best operational position and capacity of each power station on the daily load curve of an electric power system, so as to ensure the reliability and environmental protection benefits of the power system and various power supply constraint conditions, to realize the optimizing operation of power system, and to obtain the maximum benefits. Usually, the research cycle of long-term power generation scheduling is one year or several years. According to the needs, the whole operation cycle can be divided into small quarters, months, weeks, days, hours and other basic time units (period of time). Within each period of time, it is supposed that the active outputs of the generator unit keep constant. The long-term operation optimization problems include long-term hydropower and thermal power scheduling problem, fuel planning problem and long-term maintenance scheduling problem. The preparation and optimization of a power system power generation plan is an important part of the work of an electric power department. It includes the basic measures and means in the power system security and economic operation process. As the core content of the long-term optimizing operation of the power system, it will affect the sufficient supply of grid electricity and the sustainable development of energy. It has great significance.

With the rapid development of wind power generation and the expansion of power system scale, the traditional preparation method of power generation scheduling cannot meet the requirements of new trend and new conditions. As a power generating mode utilizing clean energy, wind power is popular in different countries around the world due to its extremely low power generation cost and significant environmental benefits. Wind power can bear the power system load instead of the traditional thermal power generating unit with a certain capacity, so as to reduce the consumption of traditional primary energy. When the saving of non-renewable energy resources is advocated around the world, the large-scale wind power development and utilization is the trend of power system development in the future for a relative long period. However, through the statistical analysis of features of wind power output, it is found that, due to the influence of conditions of wind energy resources, wind power output has strong stochastic volatility, and the capacity credit is not high and under most conditions exhibits obvious feature of reverse peak-load regulation. Due to these features, after the large-scale wind power is accessed to the power grid, the peak-load regulation and frequency adjustment pressure of traditional unit in the power system increase, the spinning reserve capacity increases, the safety and reliability of power system declines, and it becomes more difficult for the dispatching department to arrange the unit output plan. Especially for the preparation of output plan of the unit operating for a long term in the power system, at this time, it is difficult to predict the wind power output and to estimate errors. As the scale of installation capacity of wind power keeps increasing, the influence of wind power integration on the operation plan of power system in the medium and long term becomes more and more significant. Thus, the study on the economy and reliability of optimizing operation method in a medium and long term in the large-scale wind power system for making full use of renewable energy for power generation, saving primary energy consumption and increasing the power generation of power system is very important.

Due to the specificity of wind energy resources, it is very difficult and inaccurate to model a medium and long term wind power output model. In the current research literature, the multimode unit method and Monte Carlo analogy method are used to model for the wind power. The multimode unit method is specially used for the probabilistic production simulation of a power system. The wind farm output is equivalent to the multimode unit to represent the stochastic characteristics of wind power output. The method may consider the influence of the forced outrage of each power unit on the reliability and production cost of the power system, but it is difficult to consider various actual operation constraints of the power unit. Monte Carlo Method is a method for statistical analysis of samples. It is the general research method for the analysis on problems containing random processes. Its calculation error is inversely proportional to the square root of the number of samples. This method simulates the wind power output through the random sampling in the interval from zero to the rated output of wind power. It may consider various constraints of wind power system operation; but for the long-term planning and designing project of power system, it is difficult to accept the heavy workload of calculations and unrepeatable calculation results of this method.

### SUMMARY OF THE INVENTION

The purpose of the present invention is to propose a method for modeling a medium and long term wind power output model of a medium and long term optimal operation of a power system in view of the above problems, so as to better calculate the randomness, the volatility, the regionalism and bidirectional peak regulation performance of wind power generation and a correlation between the same and loads.

In order to achieve the above purpose, the technical solution used by the present invention is as follows:

A method for modeling a medium and long term wind power output model of a medium and long term optimal operation of a power system, including the following steps:

In the daily peak time period {t|daily load rate≧1−R} of the power system, according to the wind power confidence output distribution in the daily peak load time period, the wind power output in the typical daily peak time period is selected. The formula is as follows.

$$\{ \begin{matrix}\begin{matrix}{P}_{Wmt} ( α ) = {P}_{Wmt} {\vert}_{α} , {P}_{Wmt} {\vert}_{α} ∈ {P}_{Wm} {\vert}_{α} and \\ . t ∈ daily load peak time period\end{matrix} \\ {P}_{Wm} {\vert}_{α} = \{ {P}_{Wm}^{d} \vert {P}_{Wm}^{d} ⊆ {P}_{Wm} , and . p ( {P}_{{Wmt}_{high}} \geq {P}_{{Wmt}_{high}}^{d} ) = α \}\end{matrix}$$

In the daily valley time period {t|daily load rate≦β+R} of the power system, due to the bidirectional peak regulation performance of wind farm output, according to the peak regulation demand confidence level distribution in the wind power output day, the wind power output in the typical daily valley time period is selected. The formula is as follows.

$$\{ \begin{matrix}\begin{matrix}{P}_{Wmt} ( α ) = {P}_{Wmt} {\vert}_{α} , {P}_{Wmt} {\vert}_{α} ∈ {P}_{Wm} {\vert}_{α} and \\ . t ∈ daily load low time period\end{matrix} \\ {P}_{Wm} {\vert}_{α} = \{ {P}_{Wm}^{d} \vert {P}_{Wm}^{d} ⊆ {P}_{Wm} , and p ( {P}_{Wm . shaving} \geq {P}_{Wm . shaving}^{d} ) = α \} \\ {P}_{Wm . shaving} = {P}_{Wm} ( {t}_{high} ) - {P}_{Wm} ( {t}_{low} )\end{matrix}$$

In the daily shoulder load time period {t|β+R<daily load rate<1−R} of the power system, the formula of wind power output in the typical daily shoulder load time period is as follows.

$$\{ \begin{matrix}{P}_{Wmt} ( α ) = {P}_{Wmt} , {P}_{Wmt} ∈ {P}_{Wm} and . t ∈ daily shoulder load time period \\ {P}_{Wm} = \{ {P}_{Wm}^{d} \vert {P}_{Wm}^{d} ⊆ {P}_{Wm} , and \vert {P}_{Wm . av}^{d} - {P}_{Wm . av} \vert \leq ɛ \}\end{matrix}$$

In which, P_{Wm}|ₐ is the corresponding wind power output curve when the wind power output is at the confidence level α in the peak load time period of Month m; P_{Wmt}|_{α} is the output at time t on the corresponding wind power output curve when the wind power output is at the confidence level α in the peak load time period of Month m; P_{Wm(α)} is the wind power output curve in the typical daily of Month m at the confidence level α; P_{Wm(α)} is the output at time t on the wind power output curve in the typical daily of Month m at the confidence level α, and P_{Wm}^{d} is the wind power output set on Day d of Month m; P_{Wm} is the wind power output set of Month m; t_{high} is the daily maximum load moment of the power system; R is the spinning reserve rate of the power system; P_{Wm.shaving} is the peak regulation demand of the wind farm on days of Month m; when P_{Wm.shaving}_{_{>0}}, the wind power output has the positive peak regulation features, and when P_{Wm.shaving}_{_{<0}}, the wind power output has the negative peak regulation features; β is the daily maximum load rate of the system; t_{low} is daily maximum load moment of the power system; P_{Wmt} is the wind power output at Time t on the wind power output curve when the daily generating capacity of wind power is close to the average daily generating capacity of Month m; P_{Wm.av}^{d} is the average output of wind power on Day d of Month m; P_{Wm.av} is the average output of wind power in Month m; and ε is an arbitrary value selected.

The wind power output in the above shoulder load time period is corrected with the equivalent electric quantity, and the suitable α is selected. The modeling of wind power output model is completed.

According to the preferred embodiments of the present invention, the wind power output in the above shoulder load time period is corrected with the equivalent electric quantity, including the following steps.

Step 1: According to the actual output of wind power of Month m, Eₘ′, the average daily wind power generating capacity of the wind farm is obtained. D is the number of days in that month, i.e.

$${E}_{m}^{′} = {\sum }_{d = 1}^{D} {\sum }_{t = 1}^{24} {P}_{Wmt}^{d} / D$$

Step 2: P_{Wmt(α)}, the curve on the typical day of initial wind power output obtained, are added up hour by hour. Em, the total daily generating capacity of the wind power curve is obtained, i.e.

$${E}_{m} = {\sum }_{t = 1}^{24} {P}_{Wmt} ( α )$$

Step 3: The output in the shoulder load time period on the typical curve of the original wind power output is corrected with equal proportion. The correction factor is:

$${k}_{Em} = \frac{{E}_{{}_{shoulder} m} + ( {E}_{m}^{′} - {E}_{m} )}{{E}_{{}_{shoulder} m}}$$

$${E}_{shouderm . ,} = {\sum }_{t ∈ . shoulder load hours . ,} {P}_{Wmt} ( α )$$

$${P}_{Wmtshoulder}^{′} ( α ) = {P}_{Wmtshoulder} ( α ) \times {k}_{Em}$$

In which, E_{shoulderm} is the sum of generating capacity in the shoulder load time period on the curve on the typical day of the initial wind power output; Eₘ′−Eₘ is the deviation between the actual average daily generating capacity of wind power and power on the curve on the typical day of the initial wind power; k_{Em} is the correction factor of power in Month m.

The technical solution of the present invention has the following beneficial effects:

In the technical solution of the present invention, by calculating the wind power output of the power system during daily peak time period, daily valley time period, and daily shoulder load time period, and optimizing wind power output data during the daily shoulder load time period, the capacity substitute benefit of wind power generation is rationally taken into account, the operation reliability level of the power system is guaranteed, the bidirectional peak regulation characteristic of wind power output is considered, the peak regulation balance of the power system is guaranteed, the benefits of energy conservation and emission reduction of wind power resources are fully exerted, the highest utilization rate of the wind power generation capacity is guaranteed, the feature of low wind power schedulability is fully taken into account, the randomness and volatility of wind power output are correctly simulated, the practical situation of a simulation project optimally operating in a medium and long term in the power system is met, and the purpose of better calculating the randomness, the volatility, the regionalism and bidirectional peak regulation performance of wind power generation and a correlation between same and loads is achieved.

### SPECIFIC EMBODIMENTS OF THE INVENTION

A method for modeling a medium and long term wind power output model of a medium and long term optimal operation of a power system considers the feature of low adjustability of wind power output. P_{wit}, work output of Wind Farm i on the power system level yearly load curve, is expressed as P_{wimt}, output rate of each hour t on the typical day of Month m, i.e.

P_{Wit}=P_{Wimt}×C_{Wi}

From the statistical analysis results of wind power output feature of wind farm, one can know that P_{wimt}, the output rate each hour of the wind farm, is \tilde{R}_{Wim}, a random number between 0 and 1. Therefore, in the power system operation simulation model, how to establish the model of power generation output each hour of the wind farm has become the key to wind power generation simulation model.

For the operation scheduling of power system containing wind power, in order to ensure the maximum utilization rate of the electric quantity of wind power generation and reduce the wind power given up by the power system, first the wind power output is deducted from the forecasted load curve, and then the dispatching of other units in the power system is optimized. Based on statistical analysis of wind power output features, combined with features of the actual power generation scheduling of the power system, in order to ensure the safety and reliability of power system operation, according to the given level of assurance, the wind power output in the planning cycle is determined with the following method.

Assuming that the sample set of historical output sampling data of wind power is

P_{W}={W_{W1}, . . . , P_{Wm}, . . . , P_{WM}}

P_{Wm}={P_{Wm}¹, . . . , P_{Wm}^{d}, . . . , P_{Wm}^{D}}

P_{Wm}^{d}={P_{Wm1}^{d}, . . . , P_{Wmt}^{d}, . . . , P_{Wm24}^{d}}^{T},

P_{Wm} in this formula and that below is the wind power output set in Month m. P_{Wm}^{d} is the wind power output set on Day d of Month m. P_{Wmt}^{d} is the wind farm output at Time t on Day d of Month m. M is the number of months of sample gathering. D is the number of days of Month m.

The method for modeling a medium and long term wind power output model of a medium and long term optimal operation of a power system includes the following steps.

In the daily peak time period {t|daily load rate≧1−R} of the power system, according to the wind power confidence output distribution in the daily peak load time period, the wind power output in the typical daily peak time period is selected. The formula is as follows.

$$\{ \begin{matrix}{P}_{Wmt} ( α ) = {P}_{Wmt} {\vert}_{α} , {P}_{Wmt} {\vert}_{α} ∈ {P}_{Wm} {\vert}_{α} and \\ . t ∈ daily load peak time period \\ {P}_{Wm} {\vert}_{α} = \{ {P}_{Wm}^{d} \vert {P}_{Wm}^{d} ⊆ {P}_{Wm} , and . p ( {P}_{{Wmt}_{high}} \geq {P}_{{Wmt}_{high}}^{d} ) = α \}\end{matrix}$$

The capacity supersedure effect of wind farm is considered. The reliability level of power balance of the power system is ensured. The wind power output in the peak time period on the typical day is selected according to the wind power confidence output distribution in the daily peak load time period, i.e. the output of wind farm=the output of wind farm in the peak load time period-the output when the corresponding given confidence level on the assurance rate distribution curve is α.

In the daily valley time period {t|daily load rate≦β+R} of the power system, due to the bidirectional peak regulation performance of wind farm output, according to the peak regulation demand confidence level distribution in the wind power output day, the wind power output in the typical daily valley time period is selected. The formula is as follows.

$$\{ \begin{matrix}\begin{matrix}{P}_{Wmt} ( α ) = {P}_{Wmt} {\vert}_{α} , {P}_{Wmt} {\vert}_{α} ∈ {P}_{Wm} {\vert}_{α} and \\ . t ∈ daily load low time period\end{matrix} \\ {P}_{Wm} {\vert}_{α} = \{ {P}_{Wm}^{d} \vert {P}_{Wm}^{d} ⊆ {P}_{Wm} , and p ( {P}_{Wm . shaving} \geq {P}_{Wm . shaving}^{d} ) = α \}\end{matrix} \\ {P}_{Wm . shaving} = {P}_{Wm} ( {t}_{high} ) - {P}_{Wm} ( {t}_{low} )$$

Considering the bidirectional peak regulation performance of the output of wind farm, the reliability level of peak regulation balance of the power system is ensured. The wind power output in the valley time period on the typical day is selected according to the peak regulation demand confidence level distribution in the wind power output day, i.e. the output of wind farm=the daily peak regulation demand of wind power-the output when the corresponding given confidence level on the assurance rate distribution curve is α.

In the daily shoulder load time period {t|⊕+R≦daily load rate<1−R} of the power system, the formula of wind power output in the typical daily shoulder load time period is as follows.

$$\{ \begin{matrix}{P}_{Wmt} ( α ) = {P}_{Wmt} , {P}_{Wmt} ∈ {P}_{Wm} and . t ∈ daily shoulder load time period \\ {P}_{Wm} = \{ {P}_{Wm}^{d} \vert {P}_{Wm}^{d} ⊆ {P}_{Wm} , and \vert {P}_{Wm . av}^{d} - {P}_{Wm . av} \vert \leq ɛ \}\end{matrix}$$

In the above three formulas, P_{Wm}|ₐ is the corresponding wind power output curve when the wind power output is at the confidence level α in the peak load time period of Month m; P_{Wmt}|_{α} is the output at time t on the corresponding wind power output curve when the wind power output is at the confidence level α in the peak load time period of Month m; P_{Wm(α)} is the wind power output curve in the typical daily of Month m at the confidence level α; P_{Wmt(α)} is the output at time t on the wind power output curve in the typical daily of Month m at the confidence level α, and P_{Wm}^{d} is the wind power output set on Day d of Month m; P_{Wm} is the wind power output set of Month m; t_{high} is the daily maximum load moment of the power system; R is the spinning reserve rate of the power system; P_{Wm.shaving} is the peak regulation demand of the wind farm on days of Month m; when P_{Wm.shaving}_{_{>0}}, the wind power output has the positive peak regulation features, and when P_{Wm.shaving}_{_{<0}}, the wind power output has the negative peak regulation features; β is the daily maximum load rate of the system; t_{low} is daily maximum load moment of the power system; P_{Wmt} is the wind power output at Time t on the wind power output curve when the daily generating capacity of wind power is close to the average daily generating capacity of Month m; P_{Wm.av}^{d} is the average output of wind power on Day d of Month m; P_{Wm.av} is the average output of wind power in Month m; and ε is an arbitrary value selected.

The wind power output in the above shoulder load time period is corrected with the equivalent electric quantity, and the suitable α is selected. The modeling of wind power output model is completed.

According to the preferred embodiments of the present invention, the wind power output in the above shoulder load time period is corrected with the equivalent electric quantity, including the following steps.

Step 1: According to the actual output of wind power of Month m, Eₘ′, the average daily wind power generating capacity of the wind farm is obtained. D is the number of days in that month, i.e.

$${E}_{m}^{′} = {\sum }_{d = 1}^{D} {\sum }_{t = 1}^{24} {P}_{Wmt}^{d} / D$$

Step 2: P_{Wmt(α)}, the curve on the typical day of initial wind power output obtained, are added up hour by hour. Eₘ, the total daily generating capacity of the wind power curve is obtained, i.e.

$${E}_{m} = {\sum }_{t = 1}^{24} {P}_{Wmt} ( α )$$

Step 3: The output in the shoulder load time period on the typical curve of the original wind power output is corrected with equal proportion. The correction factor is:

$${k}_{Em} = \frac{{E}_{{}_{shoulder} m} + ( {E}_{m}^{′} - {E}_{m} )}{{E}_{{}_{shoulder} m}}$$

$${E}_{shouderm . ,} = {\sum }_{t ∈ . shoulder load hours . ,} {P}_{Wmt} ( α )$$

$${P}_{Wmtshoulder}^{′} ( α ) = {P}_{Wmtshoulder} ( α ) \times {k}_{Em}$$

In which, E_{shoulderm} is the sum of generating capacity in the shoulder load time period on the curve on the typical day of the initial wind power output; Eₘ′−Eₘ is the deviation between the actual average daily generating capacity of wind power and power on the curve on the typical day of the initial wind power; k_{Em} is the correction factor of power in Month m.

In order to fully consider the energy benefit of wind power generation, the typical day curve of initial wind power output obtained above shall be corrected with the equivalent electricity quantity. When the wind power output curve is corrected, to keep the influence of wind power output on capacity benefit and peak regulation demand of the power system in the study cycle, only the wind power output in its shoulder load time period is corrected with the equivalent electricity quantity. The specific correction steps are as follows:

Step 1: According to the actual output of wind power of Month m, Eₘ′, the average daily wind power generating capacity of the wind farm in that month is obtained. D is the number of days in that month, i.e.

$${E}_{m}^{′} = {\sum }_{d = 1}^{D} {\sum }_{t = 1}^{24} {P}_{Wmt}^{d} / D$$

Step 2: P_{Wmt(α)}, the curve on the typical day of initial wind power output obtained, are added up hour by hour. Eₘ, the total daily generating capacity of the wind power curve is obtained, i.e.

$${E}_{m} = {\sum }_{t = 1}^{24} {P}_{Wmt} ( α )$$

Step 3: The output in the shoulder load time period on the typical curve of the original wind power output is corrected with equal proportion. The correction factor is:

$${k}_{Em} = \frac{{E}_{{}_{shoulder} m} + ( {E}_{m}^{′} - {E}_{m} )}{{E}_{{}_{shoulder} m}}$$

$${E}_{shouderm . ,} = {\sum }_{t ∈ . shoulder load hours . ,} {P}_{Wmt} ( α )$$

$${P}_{Wmtshoulder}^{′} ( α ) = {P}_{Wmtshoulder} ( α ) \times {k}_{Em}$$

In which, E_{shoulderm} is the sum of generating capacity in the shoulder load time period on the curve on the typical day of the initial wind power output; Eₘ′−Eₘ is the deviation between the actual average daily generating capacity of wind power and power on the curve on the typical day of the initial wind power; k_{Em} is the correction factor of power in Month m.

In conclusion, the output curve on the typical day of wind power under the confidence level α is obtained. By selecting a suitable α, one can obtain the wind power 24-hour output curve on the typical day of each month comprehensively considering power balance, peak regulation balance and electric quantity balance of wind power output. The analog computation of a medium and long term optimal operation of the wind power system is completed with the wind power output curve obtained with the model. Considering the volatility, randomness, bidirectional peak regulation performance and other features of wind power output, the reliability and peak regulation margin of large-scale wind power system operation can be ensured.

Finally, it should be noted that the above are only the preferred embodiments of the present invention, but not used to limit the present invention. Although the present invention is described in details with reference to the above-mentioned embodiments, those skilled in the field still can modify the technical solution recorded in the above embodiments, or equally replace part of the technical features. Any modification, equivalents, improvements and so on according to the spirit and principles of the present invention shall be within the scope of the present invention.

1. A method for modeling a medium and long term wind power output model of a medium and long term optimal operation of a power system is characterized by the following steps:
in the daily peak time period {t|daily load rate≧1−R} of the power system, according to the wind power confidence output distribution in the daily peak load time period, selecting the wind power output in the typical daily peak time period, the formula being as follows,
$$\{ \begin{matrix}{P}_{Wmt} ( α ) = {P}_{Wmt} {\vert}_{α} , {P}_{Wmt} {\vert}_{α} ∈ {P}_{Wm} {\vert}_{α} and \\ . t ∈ daily load peak time period \\ {P}_{Wm} {\vert}_{α} = \{ {P}_{Wm}^{d} \vert {P}_{Wm}^{d} ⊆ {P}_{Wm} , and . p ( {P}_{{Wmt}_{high}} \geq {P}_{{Wmt}_{high}}^{d} ) = α \}\end{matrix}$$
in the daily valley time period {t|daily load rate≦β+R} of the power system, due to the bidirectional peak regulation performance of wind farm output, according to the peak regulation demand confidence level distribution in the wind power output day, selecting the wind power output in the typical daily valley time period, the formula being as follows,
$$\{ \begin{matrix}\begin{matrix}{P}_{Wmt} ( α ) = {P}_{Wmt} {\vert}_{α} , {P}_{Wmt} {\vert}_{α} ∈ {P}_{Wm} {\vert}_{α} and \\ . t ∈ daily load low time period\end{matrix} \\ {P}_{Wm} {\vert}_{α} = \{ {P}_{Wm}^{d} \vert {P}_{Wm}^{d} ⊆ {P}_{Wm} , and p ( {P}_{Wm . shaving} \geq {P}_{Wm . shaving}^{d} ) = α \}\end{matrix} \\ {P}_{Wm . shaving} = {P}_{Wm} ( {t}_{high} ) - {P}_{Wm} ( {t}_{low} )$$
in the daily shoulder load time period {t|β+R<daily load rate<1−R} of the power system, the formula of wind power output in the typical daily shoulder load time period is as follows,
$$\{ \begin{matrix}{P}_{Wmt} ( α ) = {P}_{Wmt} , {P}_{Wmt} ∈ {P}_{Wm} and . t ∈ daily shoulder load time period \\ {P}_{Wm} = \{ {P}_{Wm}^{d} \vert {P}_{Wm}^{d} ⊆ {P}_{Wm} , and \vert {P}_{Wm . av}^{d} - {P}_{Wm . av} \vert \leq ɛ \}\end{matrix}$$
wherein, P_{Wm}|ₐ is the corresponding wind power output curve when the wind power output is at the confidence level α in the peak load time period of Month m; P_{Wm}|_{α} is the output at time t on the corresponding wind power output curve when the wind power output is at the confidence level α in the peak load time period of Month m; P_{Wm(α)} is the wind power output curve in the typical daily of Month m at the confidence level α; P_{Wmt(α)} is the output at time t on the wind power output curve in the typical daily of Month m at the confidence level α, and P_{Wm}^{d} is the wind power output set on Day d of Month m; P_{Wm} is the wind power output set of Month m; t_{high} is the daily maximum load moment of the power system; R is the spinning reserve rate of the power system; R_{Wm.shaving} is the peak regulation demand of the wind farm on days of Month m; when P_{Wm.shaving}_{_{>0}}, the wind power output has the positive peak regulation features, and when P_{Wm.shaving}_{_{<0}}, the wind power output has the negative peak regulation features; β is the daily maximum load rate of the system; t_{low} is daily maximum load moment of the power system; P_{Wmt} is the wind power output at Time t on the wind power output curve when the daily generating capacity of wind power is close to the average daily generating capacity of Month m; P_{Wm.av}^{d} is the average output of wind power on Day d of Month m; P_{Wm.av} is the average output of wind power in Month m; and ε is an arbitrary value selected; and
correcting the wind power output in the above shoulder load time period with the equivalent electric quantity, and selecting the suitable α, so completing the modeling of wind power output model.

2. The method for modeling a medium and long term wind power output model of a medium and long term optimal operation of a power system according to claim 1, wherein said wind power output in the shoulder load time period is corrected with the equal electric quantity by the following steps,
step 1: according to the actual output of wind power of Month m, Eₘ′, obtaining the average daily wind power generating capacity of the wind farm, and D being the number of days in that month, i.e.
$${E}_{m}^{′} = {\sum }_{d = 1}^{D} {\sum }_{t = 1}^{24} {P}_{Wmt}^{d} / D$$
step 2: adding up hour by hour P_{Wmt(α)}, the curve on the typical day of initial wind power output obtained; Eₘ, the total daily generating capacity of the wind power curve being obtained, i.e.
$${E}_{m} = {\sum }_{t = 1}^{24} {P}_{Wmt} ( α )$$
step 3: correcting the output in the shoulder load time period on the typical curve of the original wind power output with equal proportion, and the correction factor is:
$${k}_{Em} = \frac{{E}_{{}_{shoulder} m} + ( {E}_{m}^{′} - {E}_{m} )}{{E}_{{}_{shoulder} m}}$$
$${E}_{shouderm . ,} = {\sum }_{t ∈ . shoulder load hours . ,} {P}_{Wmt} ( α )$$
$${P}_{Wmtshoulder}^{′} ( α ) = {P}_{Wmtshoulder} ( α ) \times {k}_{Em}$$
wherein, E_{shoulderm} is the sum of generating capacity in the shoulder load time period on the curve on the typical day of the initial wind power output; Eₘ′−Eₘ is the deviation between the actual average daily generating capacity of wind power and power on the curve on the typical day of the initial wind power; k_{Em} is the correction factor of power in Month m.
